(19) United States
(12) Patent Application Publication
(10) Pub. No.: US 2006/0080260 A1
(43) Pub. Date: Apr. 13, 2006

(54) System and method for digital content rights management on portable storage devices

(76) Inventors: Tien-Fu Chen, Min-Hsiung (TW); Jui-Lung Shih, Min-Hsiung (TW)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/963,668

(22) Filed: Oct. 13, 2004

(51) Int. Cl. H04L 9/00

(52) U.S. Cl. 705/52

(57) ABSTRACT

Disclosed is “System and Method for Digital Content Rights Management on Portable Storage Devices.” Due to the fact that digital content will some become the master industry in the future, a new usage rights management is needed, especially for those storage media such as portable PDA or handy flash. In conventional methods, the network has to be kept alive for determining the license validation. Conversely, the new method only needs to connect to Internet when downloading the digital content that was chosen. The digital content with personal identification and usage rights are encrypted. Henceforth, the digital content is prevented from illegal usage such as copy and unauthorized read. By the usage rights management, several kinds of limitations are defined for being operated in combination with each other, to generate various usage permissions while the overall system is easily managed. This invention is platform independent and suitable for different kinds of portable storage devices.

### FIELD OF INVENTION

This invention relates to a mechanism for managing usage rights of digital content on portable storage devices that does not require network connection and is platform independent.

Description

### BACKGROUND OF THE INVENTION

Our motivation comes from “Human Technology.” Science and technology originates from the basic human nature. What human wants and what human needs make technology products much more humanity. For this reason, there are many portable devices shown in the world, such as PDAs, digital cameras, cellular phones, MP3 players, sound recording pens, USB disks, and so on.

Digital content is a new term that refers to software, which includes materials in a number of formats, such as texts, binary data, pictures, music, audios, video clips, movies, and so forth. Since many portable devices use digital content all the time, digital content industry has become a matter of concern. However, digital content industry is all business that creates a worth by producing and distributing information service based on digital content.

Now that digital content is usually stored in portable devices, digital content industry becomes more and more important. A good usage rights management is thus needed to manage the digital content.

Due to digital content has become increasingly important, new usage rights management is needed. In conventional methods, the network needs to be kept alive for determining the license validation. Conversely, the new method needs network connection only when downloading (FIG. 2) the digital content. The digital content is encrypted by personal identification and usage rights. Henceforth, the digital content is prevented from illegal copy operations. About the usage rights management, several kinds of usage rights are defined for being operated in coordination with each other to generate various permissions. This invention can also be easily managed. This invention is suitable for all kinds of portable storage devices and platform independent.

### SUMMARY OF THE INVENTION

The object of the present invention is to provide a mechanism for managing usage rights of digital content on portable storage devices that does not require network connection and is platform independent.

The system architecture of our invention has five components, which all play important roles for guaranteeing the well operation in this system architecture. Five kinds of usage rights are also provided. When users would like to view digital contents, the license evaluator will check these usage rights for validation.

As a result of the five-component system architecture and several kinds of usage rights as proposed in this invention, four special features of good performance can be achieved, including “Offline”, “Portable Storage Devices”, “Many Usage Rights”, and “Platform Independent”.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of the five-component system architecture of this invention;

FIG. 2 is the flowchart of downloading digital content according to this invention;

FIG. 3 is a schematic drawing of the digital content provider of this invention;

FIG. 4 is a schematic drawing illustrating the content of “keyfile”;

FIG. 5 is a schematic drawing illustrating the program driver;

FIG. 6 is a schematic drawing illustrating the portable storage devices;

FIG. 7 is a schematic drawing illustrating the license evaluator.

### DETAILED DESCRIPTION OF THE PREFERRED EMBODIMENT

The object of the present invention is to provide a mechanism for managing usage rights of digital content on portable storage devices that does not require network connection and is platform independent.

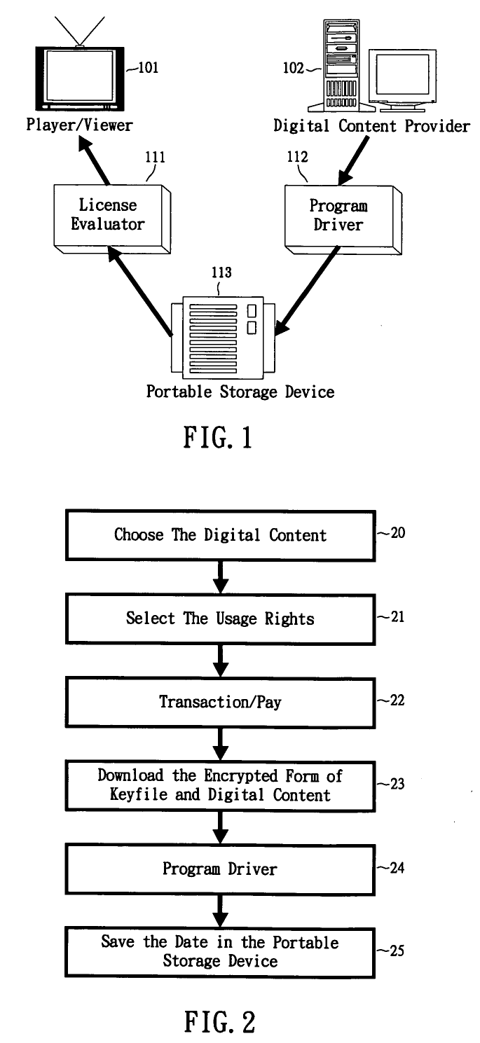

The system architecture of this invention includes five components, which all play important roles for guaranteeing the well operation in this system architecture (FIG. 1).

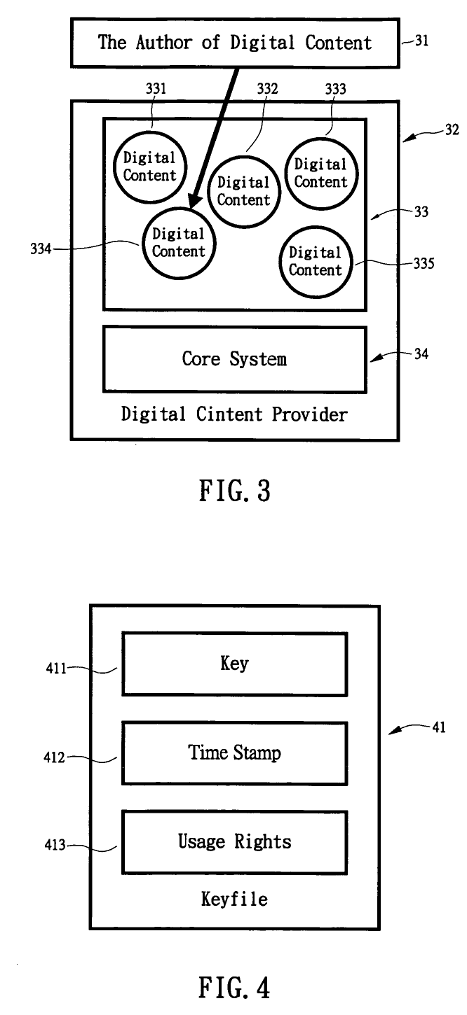

A digital content provider (32) is the first component in the system architecture, as shown in FIG. 3, which functions in accordance with its given name. The digital content provider may be a web server, which has stored several digital contents (33) authorized by the author of digital content (31). The digital content provider also provides an authorization and transaction mechanism for users to download the digital content. The authorization mechanism requires users' and the devices' unique information. Users, then, can demand the digital content and choose the usage rights. Afterwards, users pay and download the files from the digital content provider. Meanwhile. The digital content provider generates a “keyfile ” (FIG. 4) and the digital content, which are already encrypted by the personal unique information. Consequently, the downloaded files are only suitable to be downloaded by the users to the devices.

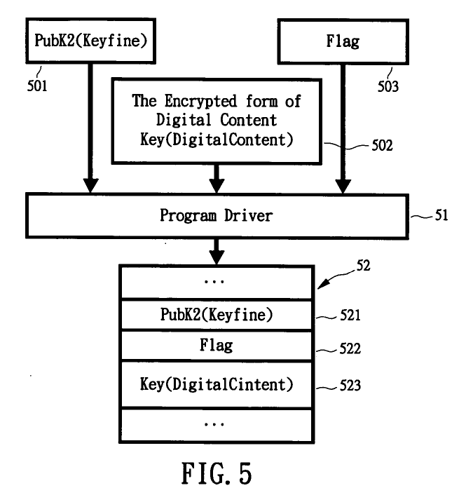

The second component in the system architecture is a program driver (51), as shown in FIG. 5. The program driver plays an important role by allowing the digital content portable among different storage devices to access the system. The task of the program driver is to write files to the portable storage devices. When writing the downloaded files, the program driver also writes some information and control flags, which are needed during license authorization or determination of usage permission. Those flags control the read operation of the digital content, and prevent the digital content from illegal copy operations. The writing information contains a “timestamp” (412) (FIG. 4) for checking the usage rights.

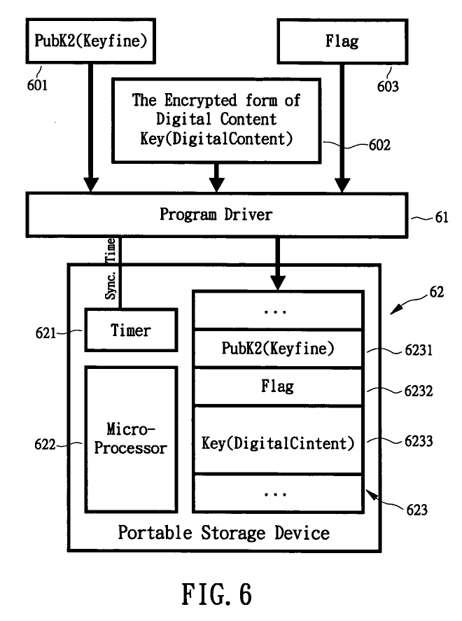

The third component in the system architecture is a portable storage device (62), as shown in FIG. 6. Users can directly access data from portable storage devices, but the digital content is in an encrypted form. Therefore, it is no use to read the encrypted data directly. The portable storage device may be provided with a microprocessor and a timer therein.

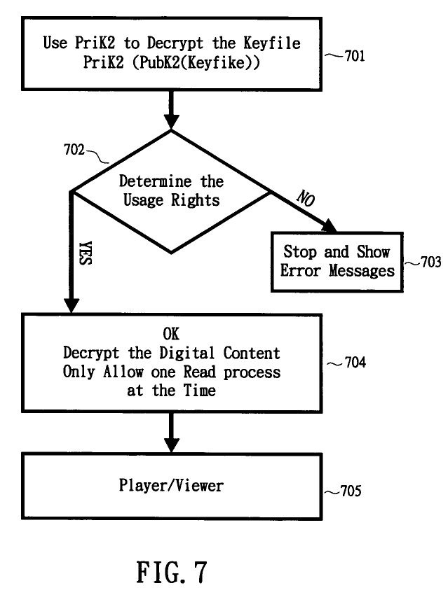

The next component in the system architecture is a license evaluator, as shown in FIG. 7. The license evaluator performs two important tasks, wherein one is to decrypt the “keyfile” (41) (FIG. 4) according to users' public key and to determine whether the usage rights are valid, and the other is to decrypt the digital content for the digital content player/viewer according to the “keyfile”.

A digital content player/viewer is the last component in the system architecture. The digital content player/viewer applicable to the system architecture is not restricted to any vendor or version of digital content reader. In other words, any kind of reader works equally fine. It is, however, a prerequisite that every player or viewer of digital content works well upon the system architecture.

Five kinds of usage rights are provided to be included in the system architecture (FIG. 1). When users would like to view the digital contents, the license evaluator will check these usage rights for validation. The license evaluator decrypts the “keyfile” (41) (FIG. 4) to obtain the usage permissions of the digital content. The license evaluator then determines whether the license of usage rights is valid. Finally, the license evaluator decrypts the digital content for reading. Five kinds of usage rights are proposed in this invention, including “How Many Devices”, “How Many Users”, “How Many Times”, “Time Slices”, and “Expired days,” where these usage rights cooperate to generate all kinds of licenses.

The first usage right defines how many devices that users use to read the digital content. Users pay for the authorization of downloading the digital content and choose whether the “How Many Devices” usage right should be enabled or not. If this usage right is enabled, users have to decide the number of “How Many Devices”, such as single device, five devices, or one hundred devices. If this usage right is disabled, users can read the digital content on any device without restrictions. If the single device is chosen, users pay less than the circumstance where multiple devices are chosen. The only difference is that digital content can be read in the unique device.

The usage right of “How Many Devices” can be used for the following situation. That is, the users who buy the digital content can take their portable storage devices with the digital content for traveling or attending a meeting and then access the digital content in someone else's devices. In this situation, users should buy the usage right of at least two devices. The license evaluator records the device's unique ID in the portable storage devices while using the digital content.

The second usage right defines how many users would like to read the digital content. Users pay for the authorization of downloading the digital content and choose whether the “How Many Users” usage right should be enabled. If the usage right is enabled, users have to decide the number of “How Many Users” such as single user, five users, or one hundred users. If this usage right is disabled, everyone can access the digital content without restrictions. If this usage right is chosen to be of single user, users pay less than the circumstance where multiple users are chosen. But only the authorized users can access digital content.

The usage right of “How Many Users” can be used for the following situation. Users who buy the digital content can take their portable storage devices with the digital content for traveling or attending a meeting and access the digital content in someone else's devices. Meanwhile, the license evaluator records the unique ID of device's owner in portable storage devices. If the number of records is greater than the number defined in this usage right, the license evaluator will not decrypt digital content. Hence, only users in the records can access the digital content.

The third usage right defines how many times the users would like to read the digital content. Users pay for the authorization of downloading the digital content and choose whether “How Many Times” usage right should be enabled. If the usage right is enabled, the users have to decide the number of “How Many Times”, such as one time, twenty times, or one hundred times. If the usage right is disabled, users can access the digital content infinite times without restrictions. If one time is chosen, the users pay less than the circumstance where multiple times are chosen, but the digital content can only be accessed once.

The usage right of “How Many Times” can be used for the following situation. The authors of digital content may promote their digital content by making a mixed digital content, which contains parts of other digital content, where the digital content with the usage right that can be accessed for one time. However, it is a good advertisement for promoting their work.

The fourth usage right defines the time slices users can access the digital content. The users pay for the authorization of downloading the digital content and choose whether “Time Slices” usage right should be enabled. If the usage right is enabled, users have to decide the range of “Time Slices”, such as from 9 a.m. to 5 p.m. If the usage right is disabled, the users can access the digital content at anytime. There are several usage rights of “Time Slices” which can be chosen, all of which are in different price tags. The digital content can only be accessed within the designated range of time slices.

The usage right of “Time Slices” can be used for the following situation. For example, if Dr. Chen is a Biology teacher who would like to give students a quiz in Biology from 9 a.m. to 10 a.m. Dr. Chen can then make a digital content with the usage right of “Time Slices” setting from 9 a.m. to 10 a.m. Accordingly, students can download the quiz in advance and take the quiz within the designated range of time.

The last usage right defines expiration days which the users can access the digital content. Users pay for the authorization of downloading the digital content and choose whether the “Expired Days” usage right should be enabled. If the usage right is enabled, users have to decide the number of “Expired Days”, such as one day, fifty days, or one hundred days. If the usage right is disabled, users can access the digital content for unlimited days without restrictions. There are several usage rights of “Expired Days” which can be chosen. If the usage right of “Expired Days” in one day is chosen, the users will pay less than the circumstance where multiple days are chosen, but the digital content can only be accessed in one day.

The usage right of “Expired Days” can be used for the following situation. For example, Chen would like to see a movie in this weekend but he has not accessed to the movie. Therefore, Chen can buy the digital content with 7 days usage right of “Expired Days”. In this case, Chen pays less than the circumstance where the usage right of more days is chosen.

Although the present invention has been explained in relation to its preferred embodiment, it is to be understood that many other possible modifications and variations can be made without departing from the spirit and scope of the invention as hereinafter claimed.

What is claimed is:

1. A method for managing usage rights of digital content, including the steps of:
a user paying for usage rights of digital content before downloading a key file and an encrypted digital content with unique personal information;
a digital content provider encrypting the digital content and the associated “keyfile” according to the personal information; and
storing both the encrypted digital content and keyfile in a portable device for accessing the usage right.

2. The method for managing usage rights of digital content as claimed in 1, the digital content provider includes an authorization and transaction mechanism for the user to download the digital content, and the authorization and transaction mechanism requires the user's and the device's unique information.

3. The method for managing usage rights of digital content as claimed in 2, wherein a program driver writes user's unique information, device's unique information, and control flags when writing the downloaded files to portable storage devices, and wherein the writing information contains the timestamp for checking the usage rights later.

4. The method for managing usage rights of digital content as claimed in 3, wherein the portable storage device contains a microprocessor and a timer for computing the usage rights of the digital content.

5. The method for managing usage rights of digital content as claimed in 3, further including the steps of:
a license evaluator decrypting the key file and the digital content according to the public key and determining whether the usage rights are valid.

6. The method for managing usage rights of digital content as claimed in 4, wherein the decrypted digital content can be played/viewed by all kinds of players/viewers.

7. Usage rights provided by a system for digital content rights management on portable storage devices, including:
a first usage right for defining how many devices a user would like to play/view a digital content;
a second usage right for defining how many users would like to play/view the digital content;
a third usage right for defining how many times the user would like to play/view the digital content;
a fourth usage right for defining time slices that the user would like to play/view the digital content; and
a fifth usage right for defining expiration days the user would like to play/view the digital content.

8. The usage rights as claimed in 7, wherein the user chooses any number of the usage rights before downloading files from a digital content provider.

9. The usage rights as claimed in 8, wherein the user pays for the chosen number of usage rights after choosing the desired usage rights based on different price tags designated to respective usage rights.
